(19) United States
(12) Patent Application Publication
(10) Pub. No.: US 2020/0201252 A1
(43) Pub. Date: Jun. 25, 2020

(54) METHOD AND DEVICE FOR PRODUCING A COMPUTER-GENERATED HOLOGRAM, A HOLOGRAM AND A LIGHTING DEVICE FOR A VEHICLE

(71) Applicant: HELLA GmbH & Co. KGaA, Lippstadt (DE)

(72) Inventor: Markus GIEHL, Lippstadt (DE)

(73) Assignee: HELLA GmbH & Co. KGaA, Lippstadt (DE)

(21) Appl. No.: 16/721,059

(22) Filed: Dec. 19, 2019

(30) Foreign Application Priority Data
Dec. 19, 2018 (DE) 10 2018 132 786.2

(51) Int. Cl. G03H 1/14; G03H 1/04; G03H 1/22

(52) U.S. Cl. CPC G03H 1/14; G03H 1/2202; G03H 1/0476

(57) ABSTRACT

A method for producing a computer-generated hologram, including the method steps of generating a reference beam, generating an object beam, imprinting computer-generated information pertaining to the hologram to the object beam, and overlapping of the object beam and the reference beam on or in a photosensitive recording medium for imprinting the hologram, wherein successively a plurality of portions of the photosensitive recording medium are simultaneously impinged upon with the object beam and the reference beam to produce a plurality of sub-holograms, and wherein the angle of incidence at which the reference beam is incident on the surface of a first portion of the recording medium is different from the angle of incidence at which the reference beam impinges upon the surface of a second portion of the recording medium.

This nonprovisional application claims priority under 35 U.S.C. § 119(a) to German Patent Application No. 10 2018 132 786.2, which was filed in Germany on Dec. 19, 2018, and which is herein incorporated by reference.

### BACKGROUND OF THE INVENTION

### Field of the Invention

The present invention relates to a method for producing a computer-generated hologram according to the preamble of claim 1, a device for producing a computer-generated hologram according to the preamble of claim 9, a hologram produced by such a method and/or produced with such a device and a lighting device for a vehicle with such a hologram.

### Description of the Background Art

A method, a device, a hologram and a lighting device of the type mentioned above are known from DE 10 2016 107 210 A1. In the method described therein, a hologram formed of a plurality of sub-holograms is imprinted in a photosensitive recording medium. In this case, the portions of the recording medium corresponding to the individual sub-holograms are successively supplied with an object beam and a reference beam. The object beam is modulated by a light modulator with computer- generated hologram information. The hologram or a hologram replica produced with the hologram as a master hologram can be integrated into a headlight of a motor vehicle.

In the production of holograms, the characteristic of the light source used for the reconstruction plays a decisive role. A change in the properties, such as the divergence, of a light source used for the reconstruction of the hologram with respect to the light source used in the production process leads to big changes in the reconstructed image. The same applies to a change in the substrate geometry to which the hologram is applied. Devices for the production of computer-generated holograms are generally limited to simple substrate shapes. Freeform substrates are limited or not possible. In the prior art, the reconstruction angle of computer-generated holograms or sub-holograms covered in the latter category is not optimized for the beam pattern of different light sources, and production methods are limited either to transmission holograms, reflection holograms or edge-lit-holograms.

### SUMMARY OF THE INVENTION

It is therefore an object of the present invention to devise a method and a device of the aforementioned type, which in the production of a hologram can take into account the properties of a light source used for the reconstruction of the hologram and/or the geometry of a substrate to which the hologram is to be applied. Furthermore, a hologram produced by such a method and/or produced with such a device and a lighting device for a vehicle with such a hologram are to be specified.

In an exemplary embodiment, it is provided that the angle of incidence at which the reference beam impinges upon the surface of a first portion of the recording medium is different from the angle of incidence at which the reference beam is incident on the surface of a second portion of the recording medium. In this way, different sub-holograms with varying angles of incidence of the reference beam can be read, so that properties of a light source used for the reconstruction of the hologram and/or the geometry of a substrate can be taken into account when writing the hologram. For example, depending on the divergence of the light sources used for reconstruction or depending on the curvature of the substrate to which the hologram is to be applied, different angles of incidence of the reference beam can be selected for different sub-holograms. In this case, it is possible to almost continuously adjust the angle between the reference and the object beams for each sub-hologram, thus creating a prerequisite for curved substrates and allowing for the adaptation to different beam patterns of a variety of light sources.

The reference beam can be reflected by a reflector, in particular a parabolic reflector, onto the sections of the recording medium. By means of the reflector, the angle of incidence of the reference beam on the recording medium can be changed by simple means.

For example, by means of different radial distances between the optical axis of the reflector and the point of incidence of the reference beam on the reflector, different angles of incidence of the reference beam can be generated on the surfaces of the portions of the recording medium. For this purpose, the reference beam can impinge upon the reflector parallel to the optical axis of the reflector.

It is possible that the photosensitive recording medium has a planar surface. Nonetheless, it can be achieved by the inventive method that the hologram can be reconstructed after it has been applied to a curved substrate.

The photosensitive recording medium can be moved between an exposure with the object beam and the reference beam for generating a first sub-hologram and an exposure with the object beam and the reference beam for generating a second sub-hologram, in particular in a plane parallel to the planar surface of the recording medium. This way, individual sub-holograms can be written successively.

In this case, the optical axis of the parabolic reflector may lie in the plane or be aligned parallel to the plane in which the photosensitive recording medium is moved between the generation of two sub-holograms.

There is the possibility that the produced computer-generated hologram is a transmission hologram or a reflection hologram or an edge-lit-hologram. It is possible to produce transmission holograms, reflection holograms and edge-lit-holograms with a single setup.

The produced computer-generated hologram can serve as a master hologram for the production of hologram replicas. For example, the hologram replicas can be read into a thin flexible film. This film can then be applied, for example, to a curved surface of a lighting device, in particular a headlight.

The optical device for overlapping the object beam and the reference beam are designed such that the angle of incidence at which the reference beam impinges upon the surface of a first portion of the recording medium is different from the angle of incidence at which the reference beam impinges upon the surface of a second portion of the recording medium. The device allows for the flexible production of holograms, which can be adapted for the application to curved substrates and to arbitrarily radiating light sources.

It can be provided that the device is suitable for carrying out a method according to the invention.

It is possible that the optical device serving to overlap the object beam and the reference beam comprise a reflector, in particular a parabolic reflector, from which the reference beam is reflected onto the photosensitive recording medium during operation of the device.

It can be provided that the device comprises an adjuster for moving the photosensitive recording medium between an exposure with the object beam and the reference beam for generating a first sub-hologram and an exposure with the object beam and the reference beam for generating a second sub-hologram, wherein the adjuster can move the recording medium in particular in a plane parallel to the planar surface of the recording medium.

It is possible that the device comprises a modulator for imprinting information pertaining to the hologram to the object beam, wherein the modulator can be designed, for example, as an LC display, preferably as an LC display operated in a reflection arrangement, which is able to generate phase shifts between different portions of the object beam.

The hologram replica, can be produced by an inventive method and/or with an inventive device, wherein the hologram is provided in particular for the application to a curved surface and/or for use with a light source having a predetermined divergence.

The lighting device for a vehicle, in particular the headlight for a vehicle, comprises a hologram according to the invention, wherein the lighting device in particular includes a curved surface on which the hologram is arranged.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective view of a portion of a device according to the invention;

FIG. 2 is a schematic sectional view of a reconstruction of a hologram according to the invention; and

FIG. 3 is a schematic sectional view of a reconstruction of a hologram according to the invention.

### DETAILED DESCRIPTION

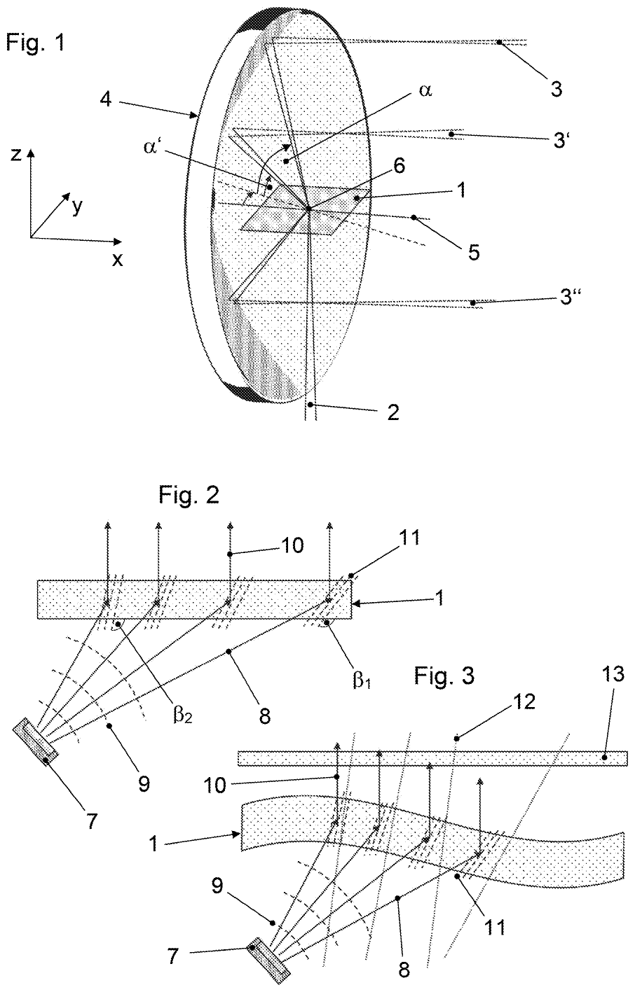

In the exemplary embodiment depicted in FIG. 1, a hologram formed of a plurality of sub-holograms is to be imprinted to a photosensitive recording medium 1 shown only schematically. The sub-holograms can be arranged side by side in a two-dimensional matrix in an x and a y direction. Photosensitive recording media 1 may consist of conventional media used in the generation of holograms. The recording medium 1 may, for example, be formed as a film that is disposed on a transparent substrate, not shown. The photosensitive recording medium 1 has a planar surface and extends in an x-y plane.

The embodiment of a device according to the invention partially shown schematically in FIG. 1 further comprises a laser light source, which generates a laser beam which is split by an optical device into an optical beam 2 and a reference beam 3. The device further comprises a modulator, which may be formed as an LC display in a reflection arrangement. The LC display can be controlled as a function of computer-generated data which relates to the creation of individual sub-holograms.

The object beam 2 can be widened onto the LC display by an optical device. As a function of the data controlling the LC display, the LC display can change the phase of portions of the object beam 2 during reflection, so that portions of the object beam 2 can exhibit a phase shift relative to other parts of the object beam 2. As a result, the object beam 2 is imprinted with information pertaining to a sub-hologram.

The device further comprises a parabolic reflector 4 facing the photosensitive recording medium 1. In this case, the optical axis 5 of the reflector 4 extends in the x-direction through the x-y plane of the planar surface of the recording medium 1. In particular, the focal point 6 of the parabolic reflector 4 is in the x-y plane of the planar surface of the recording medium 1.

Laser beams disposed in parallel with the optical axis of the parabolic reflector 4, i.e., extending in the negative x-direction, are focused into the focal point 6 of the parabolic reflector 4, wherein the angle at which they enter into the photosensitive recording medium 1 is dependent on the position in which they impinge on the reflector 4.

FIG. 1 depicts three exemplary reference beams 3, 3′, 3″, each of which are incident on the reflector 4 in the negative x-direction and thereby are spaced differently from the optical axis 5 of the reflector 4. Accordingly, also the angle at which they impinge on the recording medium 1 is different.

The reference beam 3 in FIG. 1 impinging on the reflector 4 far above the optical axis 5 impinges on the surface of the recording medium 1 at a comparatively wide angle of incidence α to the x-y plane. In contrast, the angle of incidence α′, at which the reference beam 3′ in FIG. 1 impinging on the reflector 4 is incident on the surface of the recording medium 1 further down or closer to the optical axis 5, is significantly smaller than the angle of incidence α. A variation of the position of the reference beam 3, 3′ thus results in a change in the angle of incidence α,α′ at which the reference beam 3, 3′ is incident on the recording medium 1, and thus in a change in the orientation of the Bragg planes in the hologram and in a change in the angle of incidence at which the hologram can later be reconstructed.

The object beam 2 is not reflected on the reflector 4 but instead moves in the positive z-direction upward directly into the recording medium 1 and is superimposed there by the reference beam 3, 3′, 3″. By interference with the reference beam 3, 3′, 3″, a hologram is written into the photosensitive recording medium 1 in a conventional manner.

The reflector 4 takes on two functions. On the one hand it serves to focus the reference beam 3, 3′, 3″ onto or into the recording medium 1 and on the other hand, it allows for a change in the angle of incidence of the reference beam 3, 3′, 3″. In this case, the recording medium 1 is displaceably mounted in an x-y plane in the focal point of the reflector 4. For this purpose, an adjuster for moving the photosensitive recording medium 1 are provided.

For the manufacture of the hologram, the recording medium 1 can be positioned in the x-y plane in such a manner that the object beam 2 and the reference beam 3, 3′, 3″ overlap on a first portion of the surface of the recording medium 1 so as to imprint a first sub-hologram. To this end, the object beam 2 is imprinted with the information pertaining to the first sub-hologram.

After reading the first sub-hologram, the recording medium 1 is shifted in the x-y plane until the object beam 2 and the reference beam 3, 3′, 3″ overlap on a second portion of the surface of the recording medium 1 so as to imprint a second sub-hologram. To this end, the object beam 2 is imprinted with the information pertaining to the second sub-hologram.

In this manner, all sub-holograms are gradually read into the recording medium 1.

By means of the reference beam impinging upon the side of the reflector 4 facing away from the object beam 2, reflection holograms can be written. This corresponds to the superposition of the object beam 2 in FIG. 1 with the upper reference beam 3 or the reference beam 3′ arranged slightly further down.

By means of the reference beam 3″ impinging upon the side of the reflector 4 facing the object beam 2, transmission holograms can be written. This corresponds to the superposition of the object beam 2 in FIG. 1 with the reference beam 3″ disposed below the recording medium 1.

By means of the reference beam 3′ impinging upon the reflector 4 in the vicinity of the optical axis 5, an angle of incidence can be achieved that corresponds to the critical angle of the total reflection at the interface between the recording medium 1 and the environment. This is the case for the reference beam 3′. Thus, edge-lit-holograms of both categories, transmission and reflection, can also be produced.

The flexibility in the imprinting of the holograms at different angles allows for a targeted adaptation to divergent light sources. FIG. 2 shows as a divergent light source a light emitting diode (LED) 7 and the outgoing light 8 or the wavefronts 9 of the light 8. If, despite the divergence of the light 8, the proportions 10 of the first diffraction order of the hologram reconstructed by the light 8 are to move upward in FIG. 2 in the same direction, the Bragg planes 11 of the hologram for different sub-holograms must be at a different angle to the surface of the recording medium 1. For example, in FIG. 2, the angle β₁ of the right Bragg planes 11 is significantly larger than the angle β₂ of the left Bragg planes 11.

It should be noted at this point that in FIG. 2 and FIG. 3, instead of the thin recording medium 1 only a comparatively thick plate is shown. This can be a transparent substrate to which the recording medium 1, for example, is applied in the form of a thin film.

With the device according to FIG. 1 or by means of the inventive method, suitable angles of incidence of the reference beam 3, 3′, 3″ onto the recording medium 1 can be selected during the writing of the hologram into the recording medium 1 so as to achieve suitable inclinations of the Bragg planes 11 in the hologram. The inclination of the Bragg planes 11 suitable for the divergent light source can be taken into account in the production of the computer-generated hologram without having to use the light emitting diode 7 itself in the writing process.

In the exemplary reconstruction according to FIG. 3, a light emitting diode 7 is likewise used as a divergent light source. The recording medium 1 or a substrate carrying the recording medium 1 is not planar but curved or has a curved surface.

The Bragg planes 11 of individual sub-holograms already mutually inclined due to the divergent light source must have an additional change in inclination due to the curvature of the recording medium 1 containing the hologram. This is illustrated in FIG. 3 by the effective Bragg planes 12, which represent the change in the Bragg planes due to the curvature of the recording medium 1 serving as the hologram carrier. This change in angle of the effective Bragg planes 12 when the recording medium 1 is bent relative to a planar surface 13 shown by way of example in FIG. 3 can already be taken into account in the writing process without having to use a curved recording medium in the writing process.

The computer-generated hologram produced with the device according to FIG. 1 or by means of the method according to the invention can serve as a master hologram for the production of hologram replicas. For example, the hologram replicas can be read into a thin flexible film. This film can then be applied, for example, to a curved surface of a lighting device, in particular a headlight.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a computer-generated hologram, the method comprising:
generating a reference beam;
generating an object beam;
imprinting computer-generated information pertaining to the hologram to the object beam; and
overlapping the object beam and the reference beam on or in a photosensitive recording medium for imprinting the hologram,
wherein successively a plurality of sections of the photosensitive recording medium are each simultaneously impinged upon by the object beam and the reference beam to produce a plurality of sub-holograms, and
wherein an angle of incidence at which the reference beam is incident on the surface of a first portion of the recording medium is different from an angle of incidence at which the reference beam is incident on the surface of a second portion of the recording medium.

2. The method according to claim 1, wherein the reference beam is reflected onto the portions of the recording medium by a reflector or a parabolic reflector.

3. The method according to claim 2, wherein different radial distances between the optical axis of the reflector and the point of incidence of the reference beam on the reflector and different angles of incidence of the reference beam are generated on the surfaces of the portions of the recording medium.

4. The method according to claim 1, wherein the photosensitive recording medium has a planar surface.

5. The method according to claim 1, wherein the photosensitive recording medium is moved between an exposure with the object beam and the reference beam for generating a first sub-hologram and an exposure with the object beam and the reference beam for generating a second sub-hologram in a plane parallel to the planar surface of the recording medium.

6. The method according to claim 5, wherein the optical axis of the parabolic reflector lies in the plane or is aligned parallel to the plane in which the photosensitive recording medium is moved between the generation of two sub-holograms.

7. The method according to claim 1, wherein the produced computer-generated hologram is a transmission hologram or a reflection hologram or an edge-lit-hologram.

8. The method according to claim 1, wherein the produced computer-generated hologram serves as a master hologram for the production of hologram replicas.

9. A device for producing a computer-generated hologram, comprising
a light source for generating a light beam;
optical splitter to split the light beam generated by the light source into an object beam and a reference beam;
modulater to imprint hologram-related information to the object beam; and
an optical device for overlapping the object beam and the reference beam on or in a photosensitive recording medium for imprinting the hologram,
wherein in the operation of the device successively a plurality of portions of the photosensitive recording medium are simultaneously impinged upon with the object beam and the reference beam to generate sub-holograms, and
wherein the optical device serving for overlapping the object beam and the reference beam is designed such that an angle of incidence at which the reference beam is incident on the surface of a first portion of the recording medium is different from an angle of incidence at which the reference beam impinges upon the surface of a second portion of the recording medium.

10. The device according to claim 9, wherein the light source is a laser light source.

11. The device according to claim 9, wherein the optical device serving for the overlapping of object beam and reference beam comprises a reflector or a parabolic reflector from which, during operation of the device, the reference beam is reflected onto the photosensitive recording medium.

12. The device according to claim 9, wherein the device comprises an adjuster to move the photosensitive recording medium between an exposure with the object beam and the reference beam to generate a first sub-hologram and an exposure with the object beam and the reference beam to generate a second sub-hologram, wherein the adjuster is adapted to move the recording medium in a plane parallel to the planar surface of the recording medium.

13. The device according to claim 9, wherein the device further comprises a modulater for imprinting hologram-related information to the object beam, wherein the modulater is an LC display or an LC display operated in a reflection arrangement, which generates phase shifts between different portions of the object beam.

14. A hologram, in particular a hologram replica, produced by a method according to claim 1, wherein the hologram is provided to a curved surface and/or for use with a light source having a predetermined divergence.

15. A lighting device for a vehicle, in particular a headlight for a vehicle, comprising a hologram according to claim 14, wherein the lighting device includes a curved surface on which the hologram is disposed.
